(19) United States
(12) Patent Application Publication
(10) Pub. No.: US 2025/0192526 A1
(43) Pub. Date: Jun. 12, 2025

(54) Power distribution apparatus and related methods

(71) Applicant: Prime Wire & Cable, Inc., Austin, TX (US)

(72) Inventors: Matthew Wright, Hunterville, NC (US); Steve McNamee, Charlotte, NC (US); Junfa Ye, Ningbo (CN)

(21) Appl. No.: 18/970,182

(22) Filed: Dec. 5, 2024

Related U.S. Application Data
(60) Provisional application No. 63/606,789, filed on Dec. 6, 2023.

(51) Int. Cl. H02B 1/46; H02B 1/28; H02B 1/52

(52) U.S. Cl. CPC H02B 1/46; H02B 1/28; H02B 1/52

(57) ABSTRACT

The present disclosure relates to a portable power distribution box that is capable powering more than five (5) and at least eight (8) items (in this embodiment of the invention) while complying with UL and OSHA safety regulations.

### CROSS-REFERENCE TO RELATED APPLICATIONS

See Application Data Sheet (ADS).

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of field of electrical engineering, specifically the subfield of power distribution systems, which deals with the design, construction, operation, and maintenance of devices and systems that distribute electric power to multiple loads or devices.

### Background of the Invention

Construction workers are challenged whenever jobsites have limited, unstable, or inaccessible power supplies. Workers need to use various power tools or other equipment to perform their tasks, but in this situation they may not have enough or nearby electrical power outlets to power the tools. Existing power distribution options or devices, such as direct current (DC) systems, power strips, surge protectors, and temporary power boxes, do not always allow workers to overcome the above-mentioned challenges because these options or devices are either incompatible, unsafe, inconvenient, or expensive for the workers. For example, DC systems require batteries or inverters, which are costly and bulky. For another example, power strips and surge protectors are not allowed on construction sites due to safety regulations. For instance, UL standards only allow up to five (5) power outlets on any presently available current tap. Given these small current taps are meant to be stationary, the taps are too lightweight to act as a central hub for manually operated tools that can pull in all directions on the electrical connections, and otherwise sit in the ground or are exposed to the elements. In a third example, temporary power boxes require specialized cords and connections, which are not available on most residential or small-scale projects.

In view of the foregoing, there is a need for a simple, compact, and convenient solution for powering multiple devices at remote worksites, without relying on batteries, inverters, or buckets. There is also a need for a unique and attractive design that distinguishes the solution from other portable power distribution devices. There is also a need for various features and improvements, such as more power outlets, Universal Serial Bus (USB) ports, OSHA compliant GFCI protection, elevated base, cord spindle, and collapsible dolly, that enhance the usability, durability, mobility, and versatility of the solution.

### Listing of Related Art

Related art is known and listed below:
US Published Patent Application Number 2010/0300721: Power Box
U.S. Pat. No. 11,114,878: Portable power source for power tools
US Published Patent Application Number 2022/0376529: Portable charging module capable of receiving multiple battery packs for power tools.
US Published Patent Application Number 2018/0270980: Portable power supply apparatus
US Published Patent Application Number 2015/0016027: Portable electric power distribution assembly
U.S. Pat. No. 10,158,213: Portable power distribution apparatus
U.S. Pat. No. 8,944,266: Power apparatus container
U.S. Pat. No. 9,219,341: Portable power apparatus
U.S. Pat. No. 10,594,096: Portable electric power hub
US Patent Number D964922: Portable energy storage box
US Patent Number D976212: Surge protector
US Patent Number D977438: Portable circuit control box

### SUMMARY OF THE INVENTION

In view of the foregoing, an object of this specification is to address the needs mentioned above. Another is to provide a box with multiple (more than 5) on-board power outlets that is capable of safely powering multiple tools and devices by drawing power from a single fifteen (15), twenty (20) or thirty (30) amp extension cord while keeping the power connections from the devices to the box off the ground and reducing clutter-unlike smaller residential use current taps and adapters that have fewer outlets and do not meet OSHA safety regulations for job sites. Disclosed is a simple, compact, and convenient solution for powering multiple devices at remote worksites, without relying on batteries, inverters, or buckets. Disclosed is also unique and attractive design that is distinguished from other portable power distribution devices. Disclosed is a device or system with various features and improvements, such as more power outlets, USB ports, OSHA compliant GFCI protection, elevated base, cord spindle, and collapsible dolly, that enhance the usability, durability, mobility, and versatility of the device relative to the prior art. Another objective is to provide a temporary power box that can be electrically coupled with a standard fifteen 15, twenty 20 or 30 amp power outlet and that is capable powering more than five (5) and at least eight (8) items (in this embodiment of the invention) while complying with UL and OSHA safety regulations.

A first embodiment of the disclosed subject matter is a portable power distribution box that comprises an upper box, or housing, with a top, bottom, and four sides, and two lower legs that elevate the box above the ground and keep the outlet and connected devices away from any pooled water on the ground. The top of the box has a handle that can fold into the upper surface of the box, making it easy to carry and store. The two long sides of the box each have a plurality of power outlets (e.g., four power outlets), while the two short sides have a power switch or a power connection, respectively. In some embodiments, the power switch could have a built-in resettable circuit breaker (overload protection). Additionally, in some cases there may be a separate resettable circuit breaker as an option to having it built into the power switch. The power connection can be used to power or charge the box with a 110-125 VAC input. The box also has an option for a built-in GFCI with test and reset buttons easily accessible on one of the 4 panels of the box which can protect the power outlets from ground faults. The box also has outlet covers and eaves to protect the power outlets from moisture and dust. The box provides a simple, compact, and convenient solution for powering multiple devices at remote worksites, without relying on batteries, inverters, or buckets.

A second embodiment of the disclosed subject matter is a portable power distribution box that comprises an upper box, or housing, with a top, bottom, and four sides, and a collapsible dolly with wheels that can move the box easily. The top of the box has a handle that can fold into the upper surface of the box, making it easy to carry and store. The two long sides of the box each have a plurality of power outlets (e.g., four power outlets), while the two short sides have a power switch and/or a power connection, respectively. In some embodiments, the power switch could have a built-in resettable circuit breaker (overload protection). Additionally, in some cases there may be a separate resettable circuit breaker as an option to having it built into the power switch. The power connection can be used to power or charge the box with a 110-125 VAC input. The box also has an option for a built-in GFCI with test and reset buttons easily accessible on one of the four (4) panels of the box which can protect the power outlets from ground faults. The box also has outlet covers and eaves to protect the power outlets from moisture and dust. The box also has a cord spindle and a crank secured to the box (e.g., by a collapsible dolly on which the box is mounted), which spindle and crank can help store and manage the power cord neatly. The box provides a simple, compact, and convenient solution for powering multiple devices at remote worksites, without relying on batteries, inverters, or buckets. The box also has a unique and attractive design that distinguishes it from other portable power distribution devices.

It should be noted that the preferred embodiments of the disclosed subject matter are described as “portable power distribution boxes.” However, this description should not be limited by UL rating 1640, which covers a range of portable power distribution equipment rated 600 volts or les to a maximum of 1600 amps. Instead, the term “portable power distribution box” means anything that is portable and that distributes power from an electric current tap at a jobsite or other location (regardless of the current tap's voltage or amperage).

### BRIEF DESCRIPTION OF THE SEVERAL VIEWS OF THE DRAWINGS

Other objectives of the disclosure will become apparent to those skilled in the art once the invention has been shown and described. The way these objectives and other desirable characteristics can be obtained is explained in the following description and attached figures in which:

FIG. 1 is a perspective view of a first embodiment of a power distribution box where a handle is depicted in a folded state so that an upper surface of the box is unobstructed;

FIG. 2 is another perspective view of a first embodiment of a power distribution box where the handle is depicted in an erect state such that the box is handleable but the center of the upper surface of the box is obstructed by the erect handle;

FIG. 3 is a top view of the first embodiment of the power distribution box of FIG. 1 where the upper surface and folded handle of the box are depicted;

FIG. 4 is a bottom view of the first embodiment of the power distribution box of FIG. 1 where eaves, legs, and the bottom surface of the box are depicted;

FIG. 5 is a right-side view of the first embodiment of the power distribution box of FIG. 1 where under an eave and on a side of the box are depicted a Ground Fault Circuit Interrupter (GFCI) and a covered Universal Serial Bus (USB) port;

FIG. 6 is an alternative right-side view of the first embodiment of the power distribution box of FIG. 1 where under an eave and on a side of the box a GFCI is not included such that only a covered USB port is depicted;

FIG. 7 is a left-side view of the first embodiment of the power distribution box of FIG. 1 where under an eave and on a side of the box are depicted a covered, 125 Volt (V) Alternating Current (AC) and 15, 20 or 30 Amp (A) power input plug, a reset or off power switch (e.g., a rocker switch with a built-in resettable circuit breaker for overload protection or, alternatively, the overload protection could be provided by separate resettable circuit breaker and a basic On/Off power switch (15A for basic embodiments and 20A or 30A for heavy duty embodiments), and a covered 110-125 VAC power outlet socket;

FIG. 8 is a back view of the first embodiment of the power distribution box of FIG. 1 where under an eave and on a side of the box are depicted four covered 110-125 VAC power outlet sockets;

FIG. 9 is a front view of the first embodiment of the power distribution box of FIG. 1 where under an eave and on a side of the box are depicted four covered 110-125 VAC power outlet sockets;

FIG. 10 is another perspective view of the first embodiment of the power distribution box of FIG. 1 where the plug or socket covers on the sides of the box are in an open configuration;

FIG. 11 is a top view of the first embodiment of the power distribution box of FIG. 10 where the upper surface and folded handle of the box are depicted;

FIG. 12 is a bottom view of the first embodiment of the power distribution box of FIG. 10 where eaves, opened covers with exposed digits, legs, and the bottom surface of the box are depicted;

FIG. 13 is a right-side view of the first embodiment of the power distribution box of FIG. 10 where under an eave and on a side of the box are depicted a Ground Fault Circuit Interrupter (GFCI) and exposed USB ports (2.0 or 3.0 and USB-A or USB-C or equivalent ports);

FIG. 14 is a front view of the first embodiment of the power distribution box of FIG. 10 where under an eave and on a side of the box are depicted four exposed 110-125 VAC power outlet sockets;

FIG. 15 is a left-side view of the first embodiment of the power distribution box of FIG. 10 where under an eave and on a side of the box are depicted exposed, 125 Volt (V) Alternating Current (AC) and 15, 20 or 30 Amp (A) power input plug, a reset or off switch, and an exposed 110-125 VAC power outlet socket (Please note that a 20 amp configuration would be either NEMA 5-20P or NEMA L5-20P configuration and a 30 amp configuration would be either NEMA L5-30P or L14-30P, as such locking type connectors may be required by OSHA in California, also used in generators, RV hook-ups and as such may be practical in neighboring states to California at times due to the number of California-based contractors working in Oregon, Nevada and Arizona);

FIG. 16 is a back view of the first embodiment of the power distribution box of FIG. 10 where under an eave and on a side of the box are depicted four exposed 110-125 VAC power outlet sockets;

FIG. 17 an environmental view of the power distribution box of FIG. 10 where a power socket of input power line is coupled to the power plug on the left-side of the box;

FIG. 18 is a perspective view of a second embodiment of a power distribution box where a handle is depicted in a folded state so that an upper surface of the box is unobstructed and where the box is provided with a cord spindle and a collapsible dolly depicted in a collapsed state;

FIG. 19 is another perspective view of a second embodiment of a power distribution box that is like FIG. 18 except where the handle is depicted in an erect state such that the box is handleable but the center of the upper surface of the box is obstructed by the erect handle;

FIG. 20 is a bottom view of the second embodiment of the power distribution box of FIG. 18 where eaves of the box, wheels, the dolly-base and the bottom of the cord spindle, and crank are depicted;

FIG. 21 is a top view of the second embodiment of the power distribution box of FIG. 18 where the upper surface and folded handle of the box are depicted and where the collapsed dolly handle and wheels are depicted;

FIG. 22 is a front view of the second embodiment of the power distribution box of FIG. 18 where under an eave and on a side of the box are depicted four covered 110-125 VAC power outlet sockets and where the front eave of the box, wheels, the dolly-base and the front of the cord spindle, and crank are depicted;

FIG. 23 is a left-side view of the second embodiment of the power distribution box of FIG. 18 where under an eave and on a side of the box are depicted a covered, 125 Volt (V) Alternating Current (AC) and 15, 20 or 30 Amp (A) power input plug, a reset or off power switch, and a covered 110-125 VAC power outlet socket and where the side eave of the box, a wheel, the dolly-base with notches or a catch for a cord, the side of the cord spindle, and crank are depicted;

FIG. 24 is a right-side view of the second embodiment of the power distribution box of FIG. 18 where under an eave and on a side of the box are depicted three covered 110-125 VAC power outlet sockets and a covered Universal Serial Bus (USB) port and where the side eave of the box, a wheel, the dolly-base with notches or a catch for a cord, and the side of the cord spindle are depicted;

FIG. 25 is a back view of the second embodiment of the power distribution box of FIG. 18 where under an eave and on a side of the box a GFCI is not depicted while parts of the cord spindle, the crank, the collapsed dolly handle and wheels are depicted;

FIG. 26 is an alternative back view of the second embodiment of the power distribution box that is like FIG. 25 except that a GFCI is not depicted;

FIG. 27 another perspective view of the second embodiment of the power distribution box of FIG. 18 where the plug or socket covers on the sides of the box are in an open configuration;

FIG. 28 is a bottom view of the second embodiment of the power distribution box of FIG. 27 where eaves and opened covers with exposed digits of the box, wheels, the dolly-base and the bottom of the cord spindle, and crank are depicted;

FIG. 29 is a top view of the second embodiment of the power distribution box of FIG. 27 where the upper surface, opened covers, and folded handle of the box are depicted and where the collapsed dolly handle and wheels are depicted;

FIG. 30 is a left-side view of the second embodiment of the power distribution box of FIG. 18 where under an eave and on a side of the box are depicted a exposed, 110-125 VAC and 15, 20 or 30 Amp power input plug, a reset or off power switch, and a exposed 110-125 VAC power outlet socket and where the side eave of the box, a wheel, the dolly-base with notches or a catch for a cord, the side of the cord spindle, and crank are depicted;

FIG. 31 is a front view of the second embodiment of the power distribution box of FIG. 27 where under an eave and on a side of the box are depicted four exposed 110-125 VAC power outlet sockets and where the front eave of the box, wheels, the dolly-base and the front of the cord spindle, and crank are depicted;

FIG. 32 is a right-side view of the second embodiment of the power distribution box of FIG. 27 where under an eave and on a side of the box are depicted three exposed 110-125 VAC power outlet sockets and an exposed USB port and where the side eave of the box, a wheel, the dolly-base with notches or a catch for a cord and the side of the cord spindle are depicted;

FIG. 33 is a back view of the second embodiment of the power distribution box of FIG. 27 where under an eave and on a side of the box a GFCI is depicted while parts of the cord spindle, the crank, the collapsed dolly handle and wheels are also depicted;

FIG. 34 is another perspective view of the second embodiment of a power distribution box that is like FIG. 18 except where an extension cord is plugged in to the box;

FIG. 35 is another perspective view of the second embodiment of a power distribution box that is like FIG. 18 except where the handle of the collapsible dolly is extended such that the dolly is operable to move the box;

FIG. 36 is another perspective view of the second embodiment of a power distribution box that is like FIG. 18 except where the spindle features a wound cord;

FIG. 37 is a bottom view of the second embodiment of the power distribution box of FIG. 35 that shows a power socket of the cord secured by a catch on the side of the dolly; and,

FIG. 38 is a front view of the second embodiment of the power distribution box of FIG. 35 that shows a power socket of the cord secured by a catch on the side of the dolly.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

The present disclosure relates to a portable power distribution box that enables users to connect and power multiple power tools or other equipment simultaneously without requiring nearby electrical power outlets. The box comprises an upper box, or housing, with a top, bottom, and four sides, and a lower support structure that elevates the box above the ground. The top of the box has a handle that can fold into the upper surface of the box, making it easy to carry and store. The two long sides of the box each have a plurality of power outlets (e.g., four power outlets), while the two short sides have a power switch and/or a power connection, respectively. In some embodiments, the power switch could have a built-in resettable circuit breaker (overload protection). Additionally, in some cases there may be a separate resettable circuit breaker as an option to having it built into the power switch. A preferred embodiment includes the circuit breaker built into the power switch. In some embodiments, overload protection is prioritized such that the box may include either a built-in breaker in the power switch or a separate resettable circuit breaker. A preferred embodiment includes the circuit breaker built into the power switch. In some cases, the power switch may have a weatherproof boot for potential outdoor rating and to prevent accidentally turning off the unit. This feature may be unlike typical temporary power boxes since such boxes do not have a master on/off power switch. Typical boxes instead have individual outlet overload protection (resettable circuit breakers) and workers usually prefer this feature to prevent everyone who is tapping off the power box from losing power whenever one user is overloading one circuit, but the present disclosure describes devices that are capable of a tap off a standard receptacle without having to utilize a job site power pole, and the overload protection may be for the entire circuit, not for individual power outlets on the box. The power connection can be used to power or charge the box with a 110-125 VAC input. The box also has an option for a built-in GFCI with test and reset buttons easily accessible on one of the four (4) panels of the box which can protect the power outlets from ground faults. The box also has outlet covers and eaves to protect the power outlets from moisture and dust. The box provides a simple, compact, and convenient solution for powering multiple devices at remote worksites, without relying on batteries, inverters, or buckets. The box also has a unique and attractive design that distinguishes it from other portable power distribution devices. The details of this disclosure are described in connection with the figures.

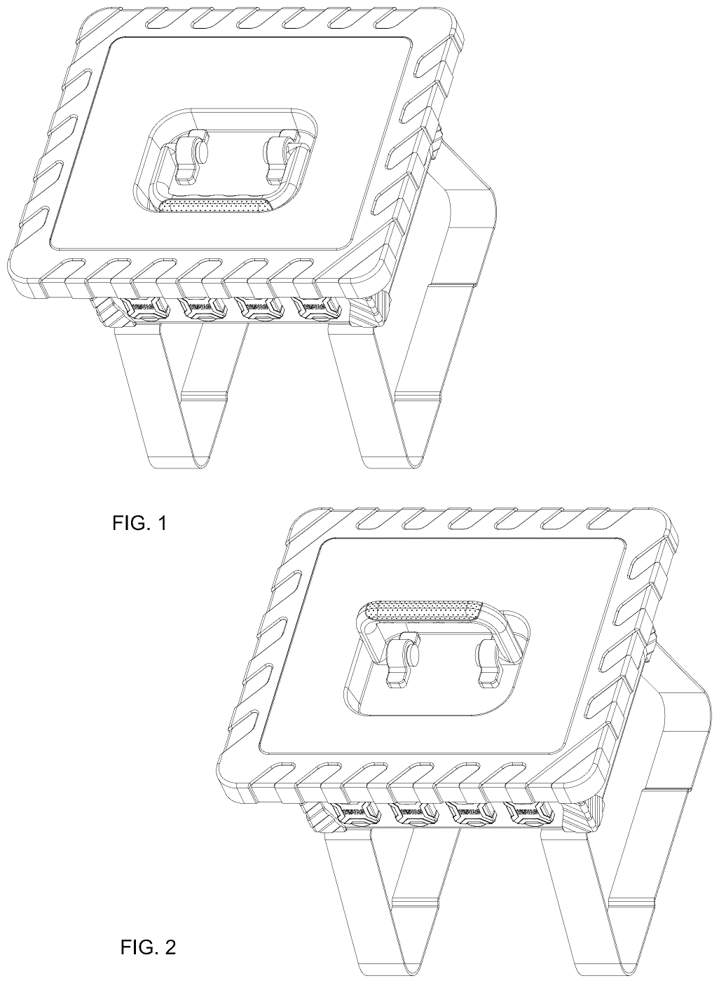

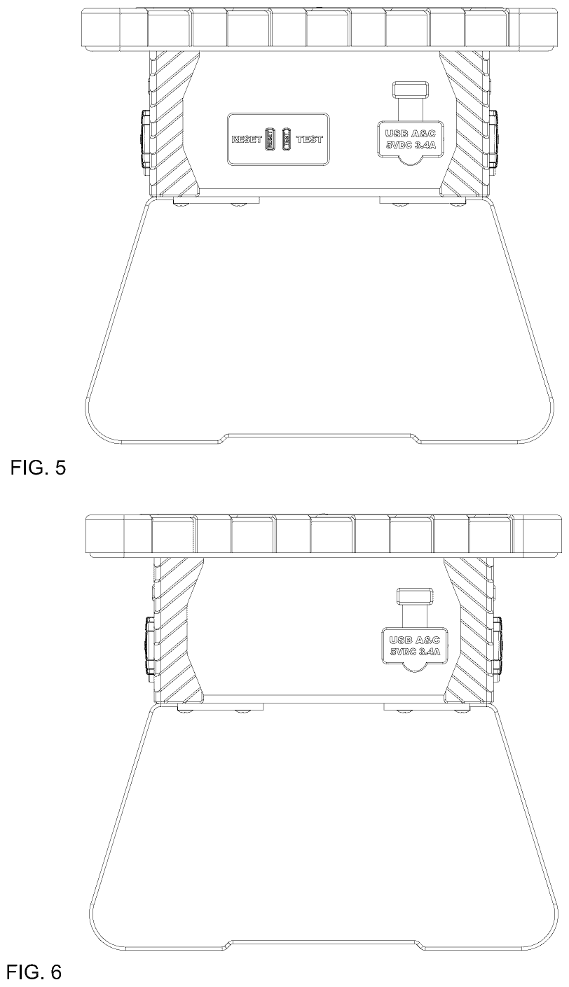

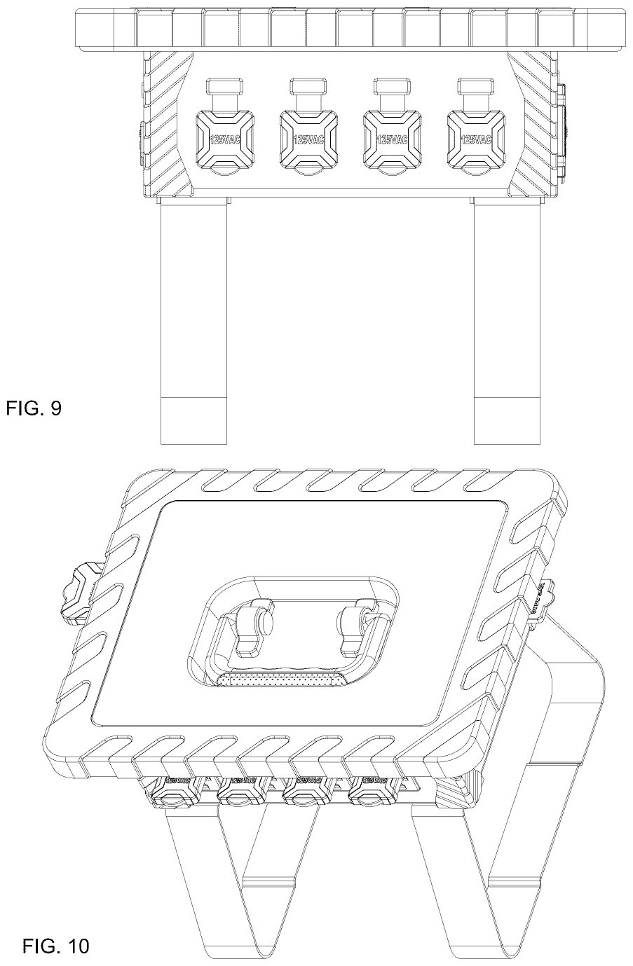

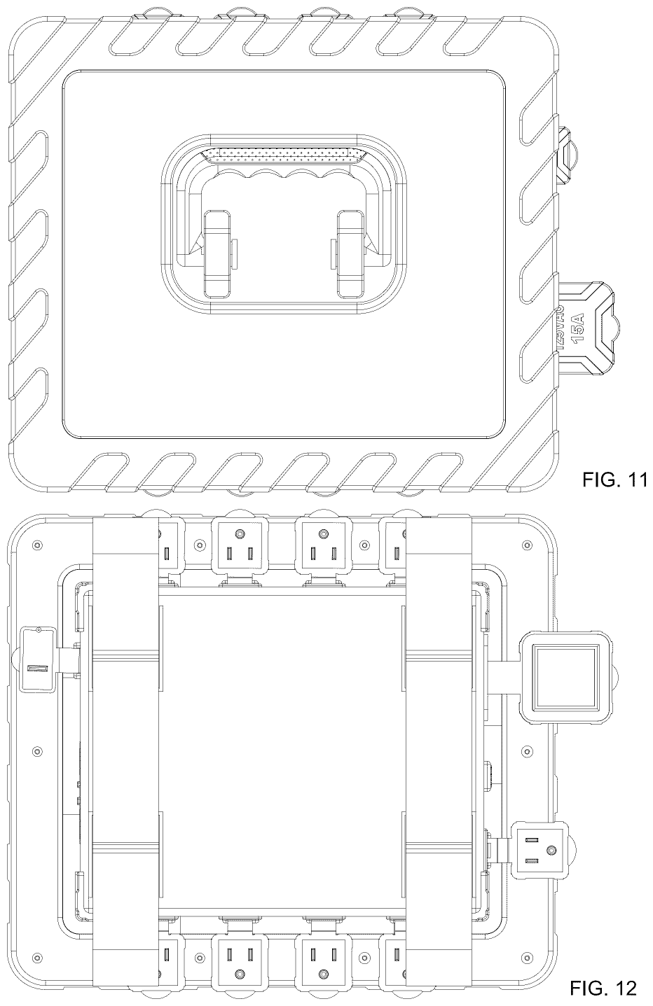

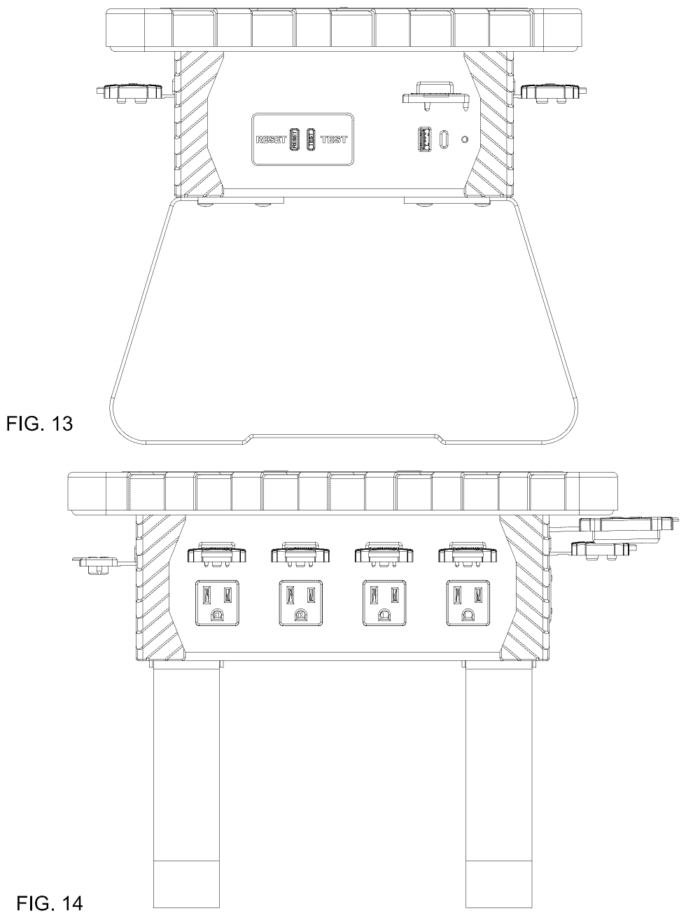

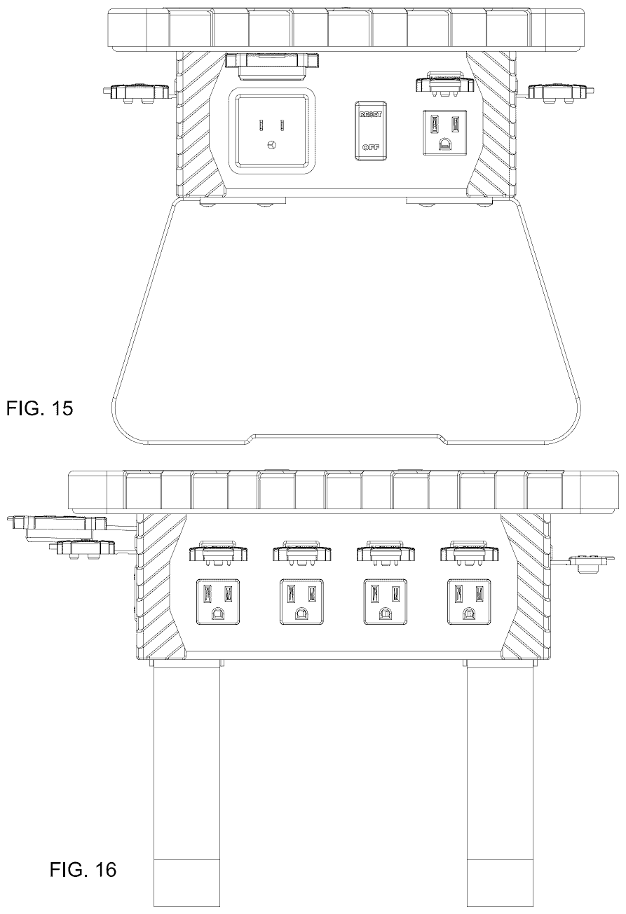

The first embodiment of the disclosed subject matter is a portable power distribution box that comprises an upper box, or housing, with a top, bottom, and four sides, and two lower legs that elevate the box above the ground. The box is designed to distribute electric power to multiple power tools or other equipment simultaneously without requiring nearby electrical power outlets. The box is especially useful for construction sites, where power supply is often limited, unstable, or inaccessible. The first embodiment is depicted in FIGS. 1 through 17.

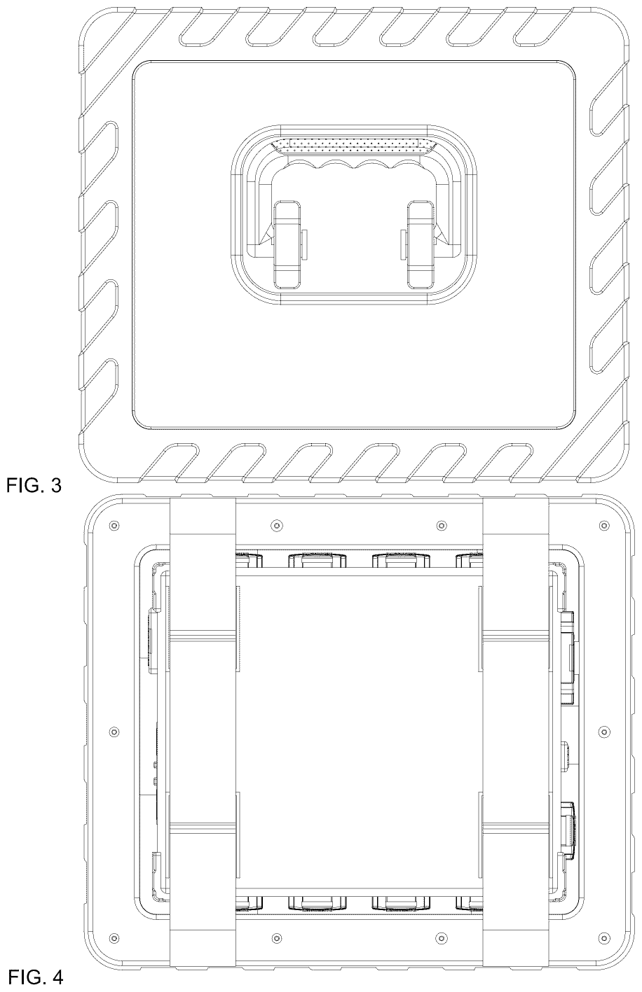

As shown in FIGS. 1 and 2, the top of the box has a handle that can fold into the upper surface of the box, making it easy to carry and store. When the handle is folded into the top surface of the box, the top surface is usable as a work space or table top. The handle is attached within a depression of the top of the box by hinges or other suitable means. The handle can be locked in a folded or an erect position by a latch or other suitable means. The handle is made of a durable and ergonomic material, such as metal, plastic, or rubber.

As shown in FIGS. 1, 2, 5 through 10 and 13 through 17, the two long sides of the box each have a plurality of power outlets (e.g., four power outlets), while the two short sides have additional power outlets, a power switch, and/or a power connection. The power outlets may be standard NEMA 5-15R grounded power outlets that can provide 110-125 VAC and 15 A of power to any connected devices. Other embodiments may be compatible with a NEMA5-15R or 5-20R w/T-slot receptacles for the outlets to accept either standard NEMA 5-15P (15 amp) or NEMA 5-20P (T-blade 20 amp) plugs or sockets. Some embodiments may be compatible with California rules and regulations. For instance, in California, OSHA requires twist-to-lock (L5-20P or L-14-20P) on job sites whereas the rest of the country accepts the T-blade 5-20P such that a NEMA 5-20P is the style of power connector employed by the box in this and related figures. Additionally, if used with a generator or power inverter, other embodiments might necessitate compatibility with a NEMA L5-30R or L14-30R 30 amp twist-to-lock receptacle. The power outlets are spaced apart from each other to allow: (1) easy plugging and unplugging of the devices; and (2) use of devices that have oversized transformer plugs (as opposed to standard sized plugs) without blocking use of the adjacent outlets. The power outlets are also protected by outlet covers that can prevent moisture and dust from entering the power outlets. The outlet covers have digits in some cases that penetrate the outlet sockets and the covers are attached to the sides of the box by hinges or other suitable means. The outlet covers can be opened or closed by a latch or other suitable means.

Still referring to the same figures, the power switch may be a toggle or rocker switch that can control the power flow to the box and the connected devices. In one embodiment, control of the power may include overload protections. The power switch is clearly labeled and visible on the side of the box. The power switch may also be responsive and effective in cutting off the power during an overload situation when needed.

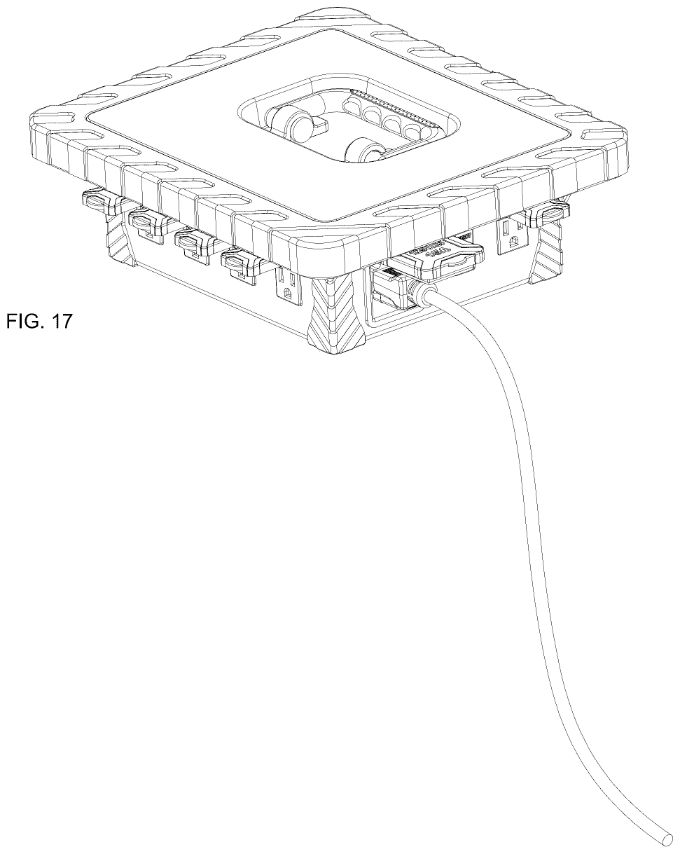

Referring to FIG. 17, the power connection is a standard NEMA 5-15P or a NEMA 5-20P grounded plug that can be connected to a standard 15 or 20 A extension cord that provides the power input to the box. Embodiments may be compatible with a NEMA5-15R or 5-20R receptacle on an extension cord. Some embodiments may be compatible with California rules and regulations. For instance, in California, OSHA requires twist-to-lock (L5-20P or L-14-20P) on job sites whereas the rest of the country accepts the T-blade 5-20P such that a NEMA 5-20P is the style of socket employed by the box in this and related figures. Additionally, if used with a generator or power inverter, other embodiments might necessitate compatibility with a NEMA L5-30R or L14-30R 30 amp twist-to-lock receptacle. As set forth above, the electrical load rating of the cord may be determined by the plug. That said, the length and gauge of an extension cord used to power this box should meet OSHA and other safety/electrical code requirements, but as set forth earlier, the intent is for this box to be compatible with standard, accessible properly sized and rated extension cords readily available in the marketplace.

In the most preferred embodiment, for example, the power connection can generally or in the preferred embodiment be used to power or charge the box with a 110-125 VAC input. Yet still, in other embodiments may be compatible with specific rules and codes such as California OSHA requiring locking connections on job sites so that another embodiment would require a NEMA L5-20P power input plug instead of the NEMA 5-20P, or when connecting to a generator or power inverter, a NEMA L5-30P or L14-30P 30 Amp input plug would be utilized. Additionally, UL, OSHA and other safety standards would require use with an extension cord made to conduct a sufficient electrical load from the power supply (power outlet) which would include a minimum wire gauge and maximum length extension cord used to carry the electrical load from the power supply (power outlet) to the box. Such codes and conditions have been considered in the design of this box. The power connection is also protected by a cover that can prevent moisture and dust from entering the plug. The cover is attached to the side (e.g., right side) of the box by hinges or other suitable means. The cover can be opened or closed by a latch or other suitable means.

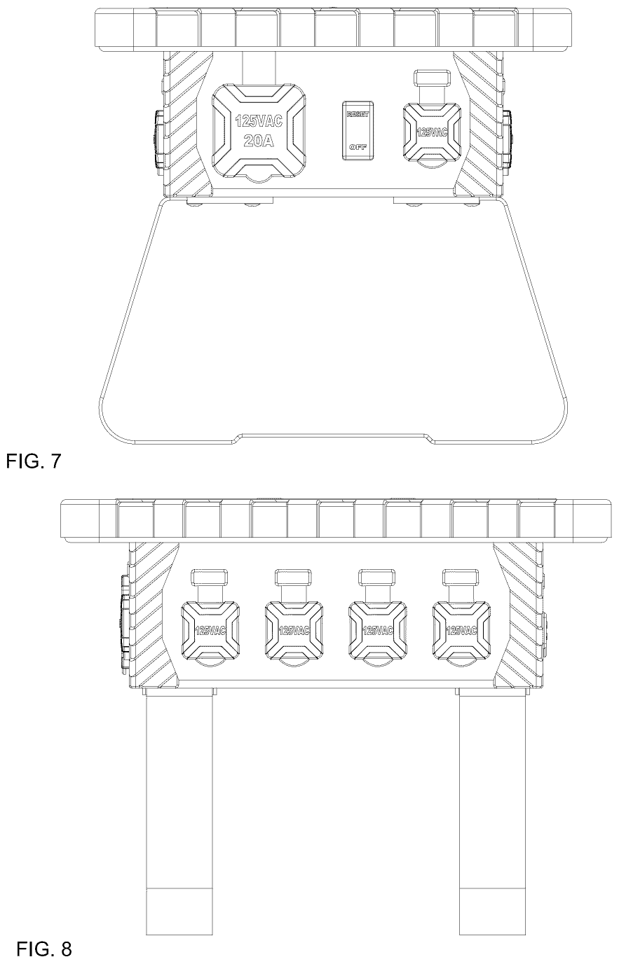

As shown in FIGS. 5 and 6, the box also has an option for a GFCI built into the box, which can protect the power outlets from ground faults. The GFCI is a device that can detect and interrupt the current flow when a ground fault occurs, such as when a person touches a live wire or a device malfunctions. The GFCI is clearly visible and accessible from the back of the box. The GFCI test and rest buttons are clearly visible and accessible from a side panel of the box that can be used to check and restore the functionality of the GFCI. The GFCI also has an indicator light that can show the status of the GFCI, such as green for normal, red for fault, or off for no power. The box also has an option for one or more USB ports on the right-side of the box, which can provide sufficient power to charge various devices, such as portable lights and other rechargeable tools & devices used on a job site, cell phones, speakers, or fans. The USB ports are compatible with different types of devices, such as Android, Apple, or Windows. The USB ports are also protected by a cover that can prevent moisture and dust from entering the port. The cover is attached to the side of the box by hinges or other suitable means. The cover can be opened or closed by a latch or other suitable means.

As shown most directly in FIGS. 1, 2, 10 and 17, the box also has eaves that extend from the top of the box over the sides of the box. The eaves provide additional protection to the power outlets, the power switch, the power connection, and the GFCI from moisture and dust. The eaves also provide shade and ventilation to the box and the connected devices. The eaves are made of a durable and weather-resistant material, such as metal, plastic, or wood.

As shown in FIGS. 1, 2, 4 through 10, and 12 through 16, the two lower legs are fixed to the bottom of the box by screws or other suitable means. The legs raise the box off the ground to prevent the box and the connected devices from contacting water or dirt. The legs also provide stability and support to the box and the connected devices. The legs are made of a sturdy and rigid material, such as metal, plastic, or wood.

The box provides a simple, compact, and convenient solution for powering multiple devices at remote worksites, without relying on batteries, inverters, or buckets. The box also has a unique and attractive design that distinguishes it from other portable power distribution devices. The box incorporates various features and improvements, such as more power outlets, USB ports, GFCI protection, elevated base, cord spindle, and collapsible dolly, that enhance the usability, durability, mobility, and versatility of the box.

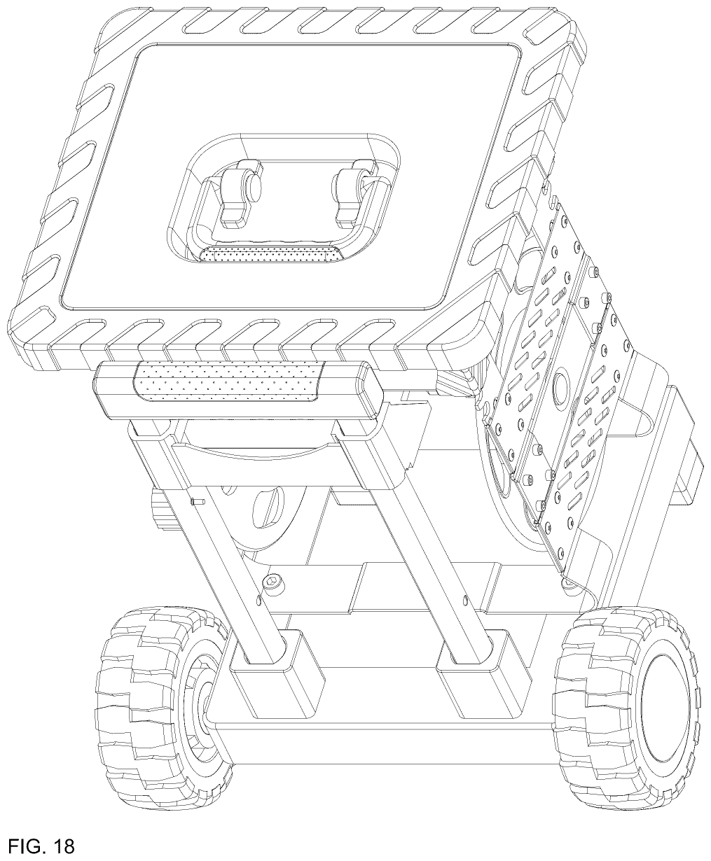

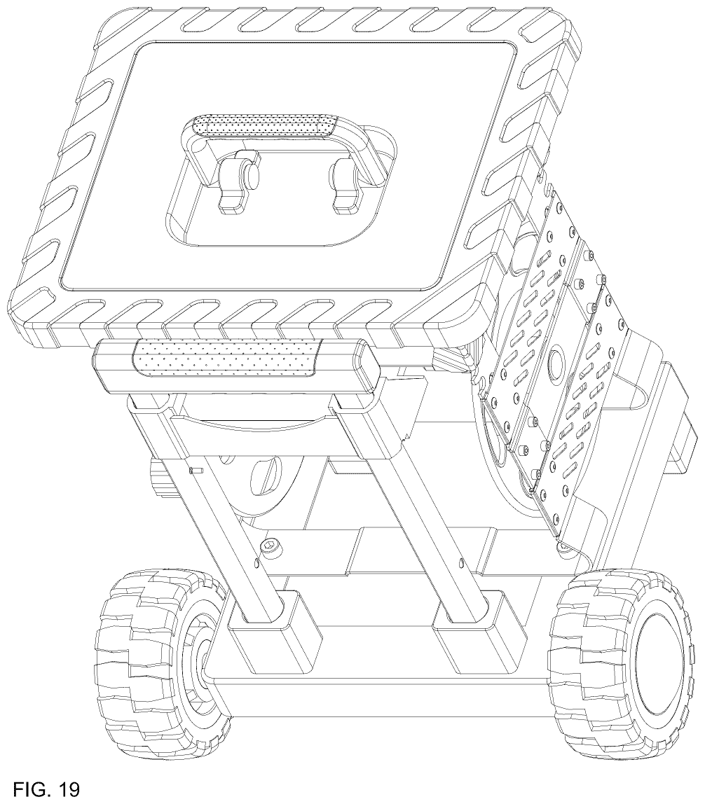

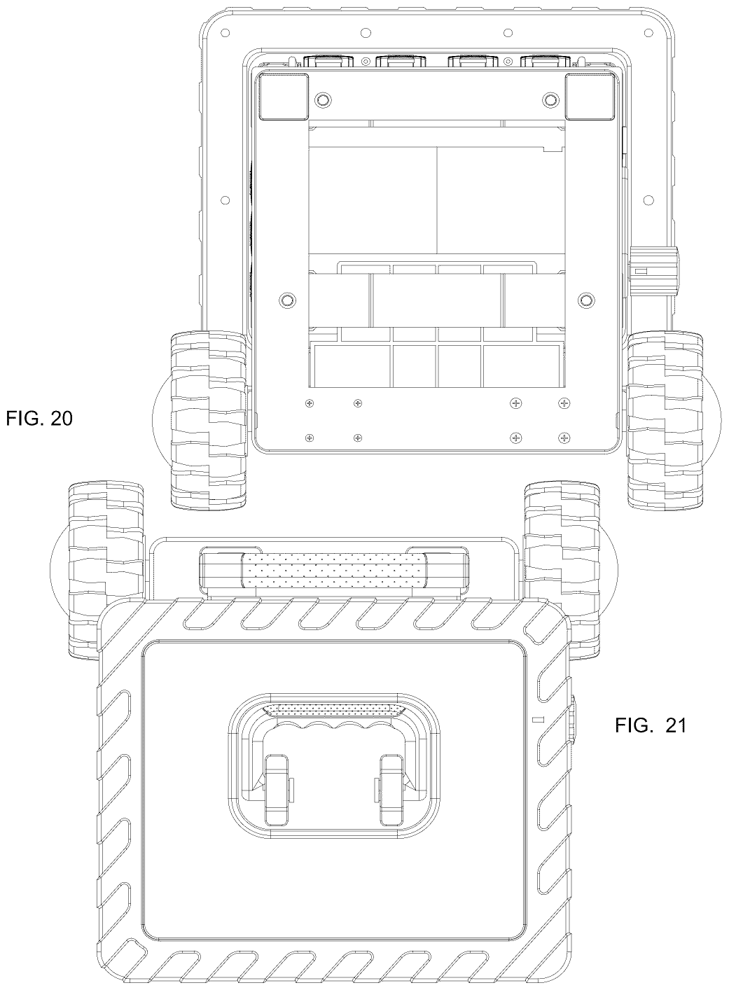

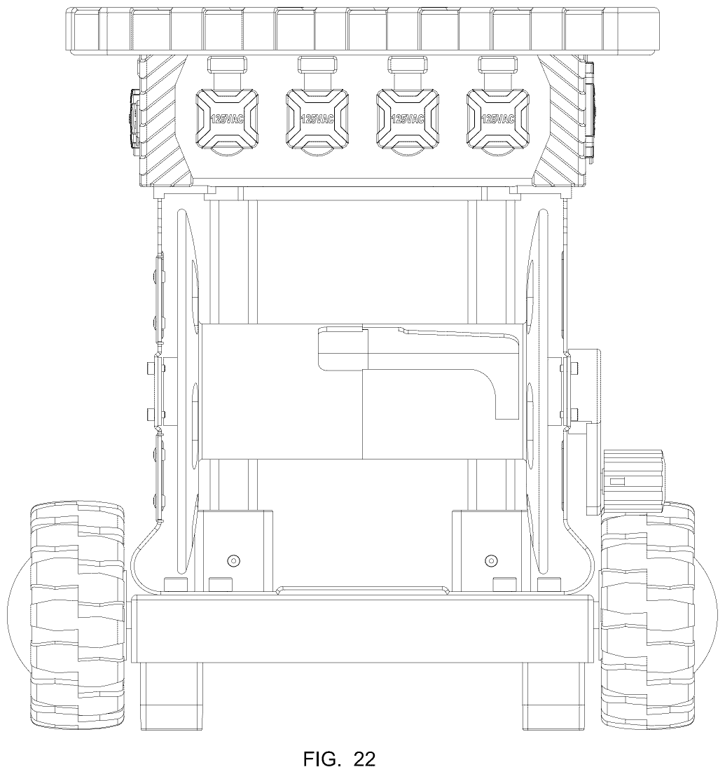

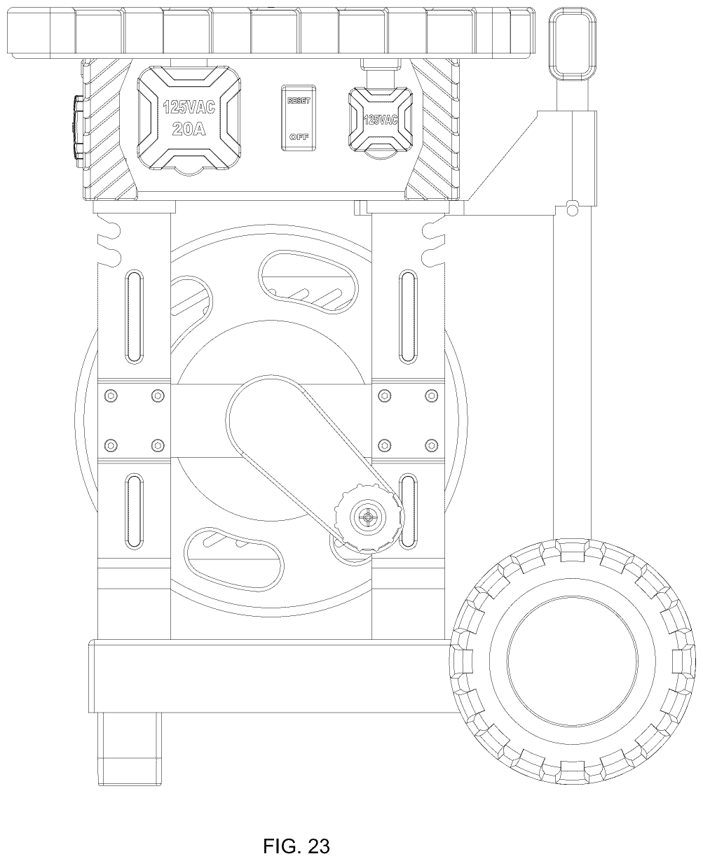

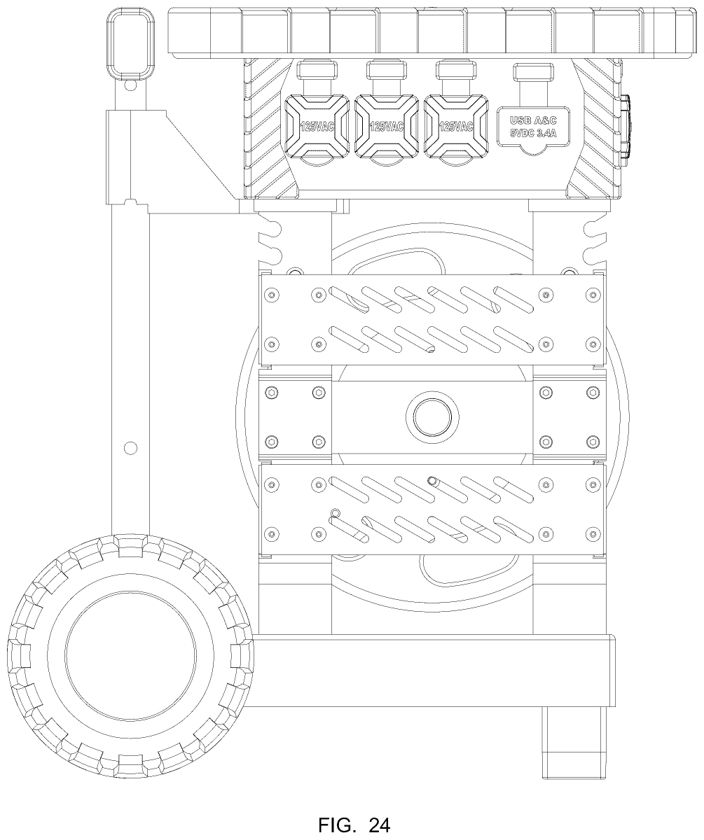

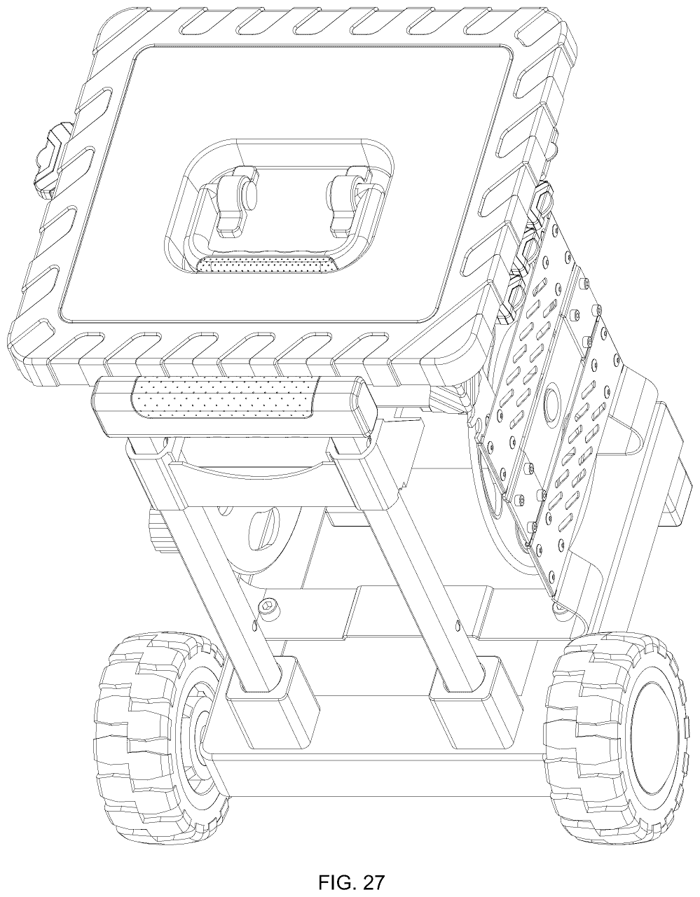

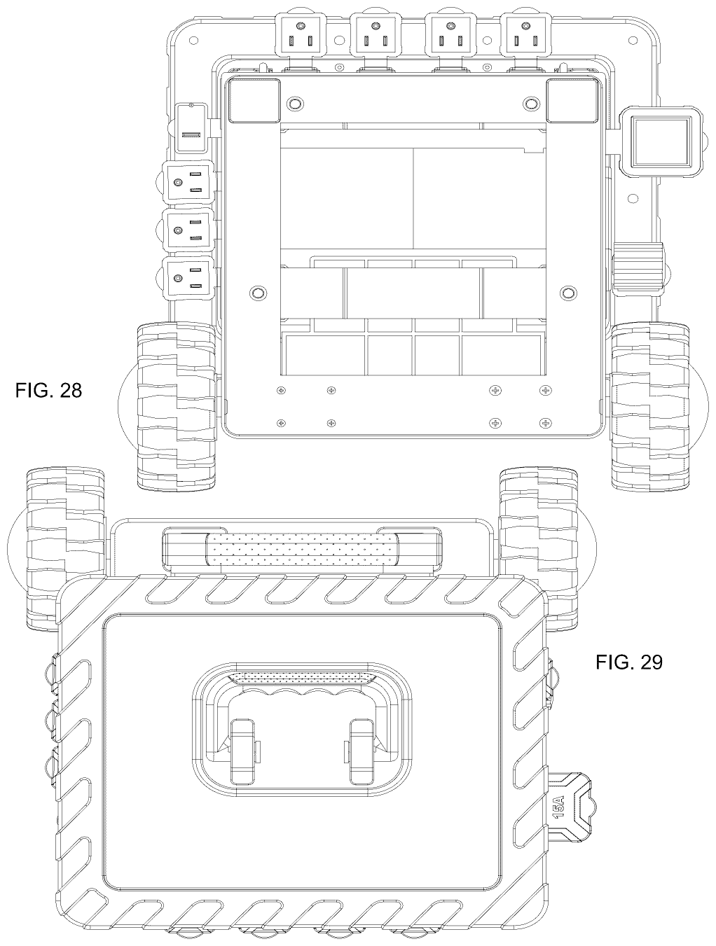

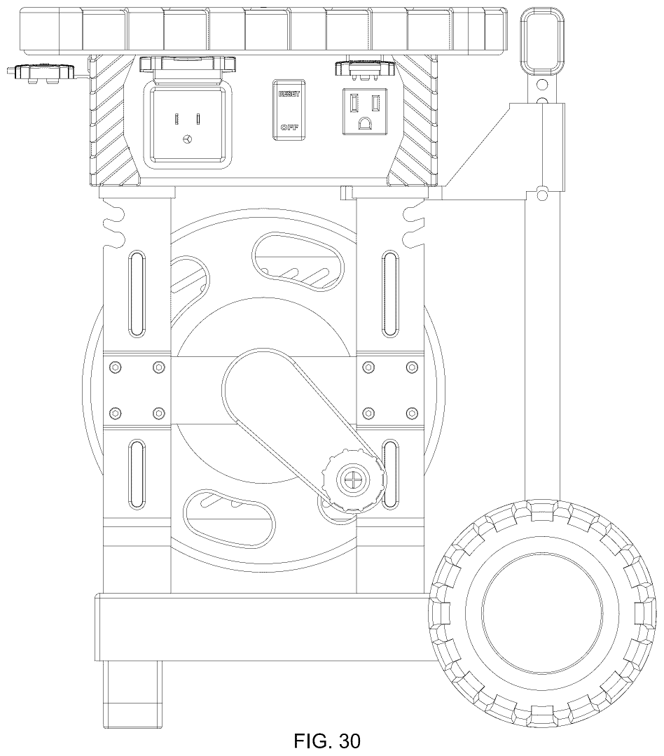

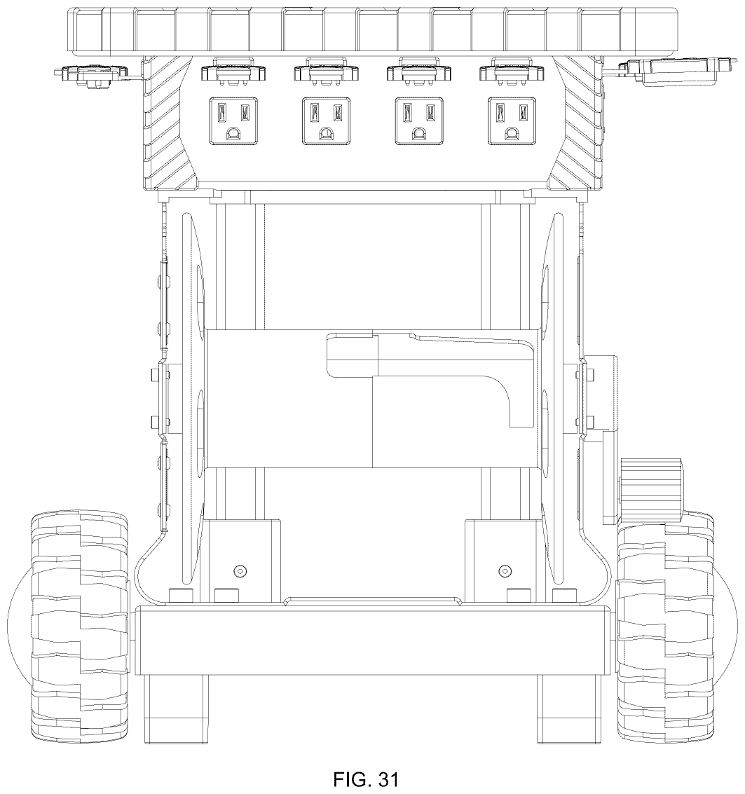

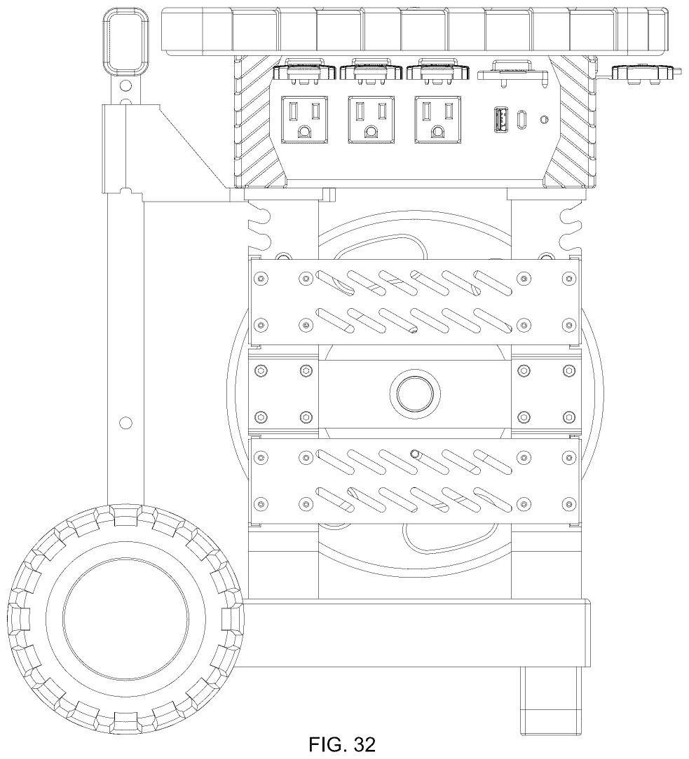

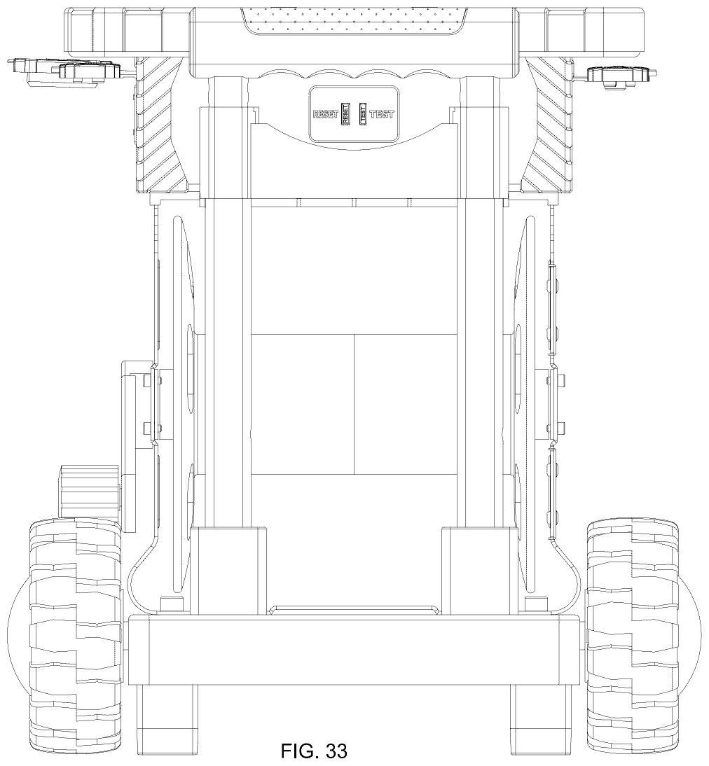

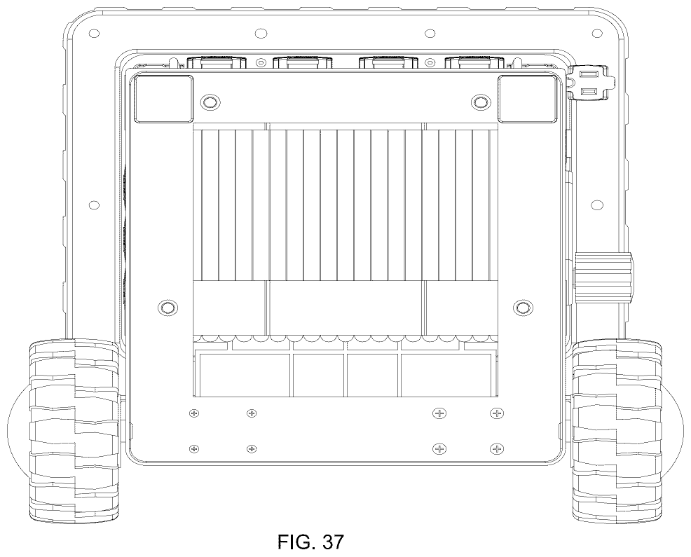

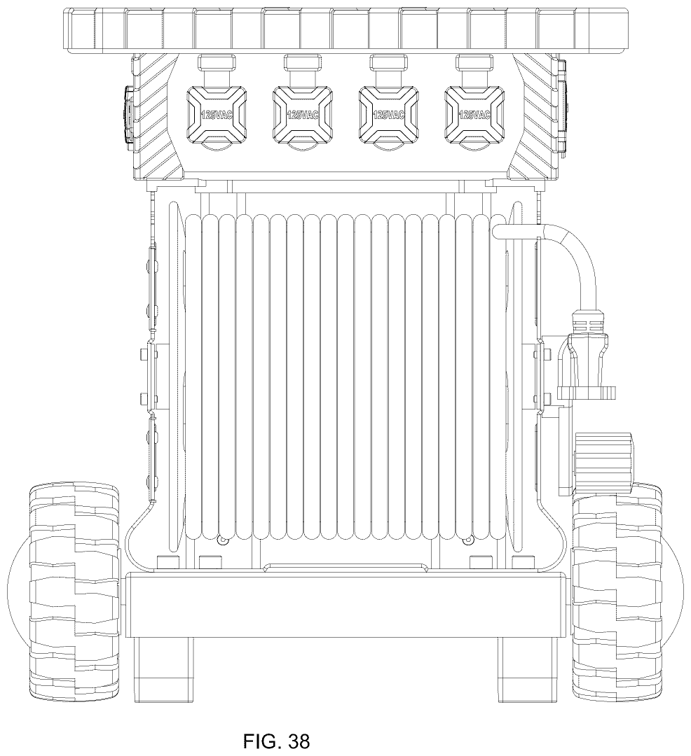

The second embodiment of the invention is a portable power distribution box that comprises an upper box, or housing, with a top, bottom, and four sides, and a collapsible dolly with wheels that can move the box easily. The box is designed to distribute electric power to multiple power tools or other equipment simultaneously without requiring nearby electrical power outlets. The box is especially useful for construction sites, where power supply is often limited, unstable, or inaccessible. The second embodiment is depicted in FIGS. 18 through 38.

As shown in FIGS. 18, 19, 21, 27, 29, and 34 through 36, the top of the box has a handle that can fold into the upper surface of the box, making it easy to carry and store. The handle is attached to the top of the box by hinges or other suitable means within a depression in the top. The handle can be locked in a folded or an erect position by a latch or other suitable means. When the handle is folded, the top of the box can be used as a work place or a table top. The handle is made of a durable and ergonomic material, such as metal, plastic, or rubber.

As shown in FIGS. 18 through 38 the front side of the box has a plurality of power outlets (e.g., four power outlets), while the two short sides have additional power outlets, a power switch, and/or a power connection. The power outlets may be standard NEMA 5-15R grounded power outlets that can provide 110-125 VAC and 15 A of power to the connected devices although in some embodiments, NEMA 5-20R (T-slot 15/20 amp compatible) or NEMA L5-20R (locking style as required by Cal OSHA) outlets may be used. The power outlets are spaced apart from each other to allow for easy plugging and unplugging of the devices. The power outlets are also protected by outlet covers that can prevent moisture and dust from entering the power outlets. The outlet covers are attached to the sides of the box by hinges or other suitable means. The outlet covers can be opened or closed by a latch or other suitable means. The power switch is a toggle switch that can control the power flow to the box and the connected devices. The power switch is clearly labeled and visible on the side of the box. The power switch may also be responsive and effective in cutting off the power during an overload situation when needed.

As with the first embodiment, the power connection of the second embodiment may be a standard NEMA 5-15P grounded or NEMA 5-20P plug that can be connected to a standard 15 or 20 A extension cord (or other configurations as previously noted) that provides the power input to the box. The power connection can be used to power or charge the box with a 110-125 VAC input. The power connection is also protected by a cover that can prevent moisture and dust from entering the plug. The cover is attached to the side of the box by hinges or other suitable means. The cover can be opened or closed by a latch or other suitable means.

As shown in FIGS. 18, 24, 27, and 32, the box also has an option for one or more USB ports on the right-side of the box, which can provide power to charge various devices, such as cell phones, speakers, or fans. The USB ports are compatible with different types of devices, such as Android, Apple, or Windows. The USB ports may also be protected by a cover that can prevent moisture and dust from entering the port. The cover is attached to the side of the box by hinges or other suitable means. The cover can be opened or closed by a latch or other suitable means.

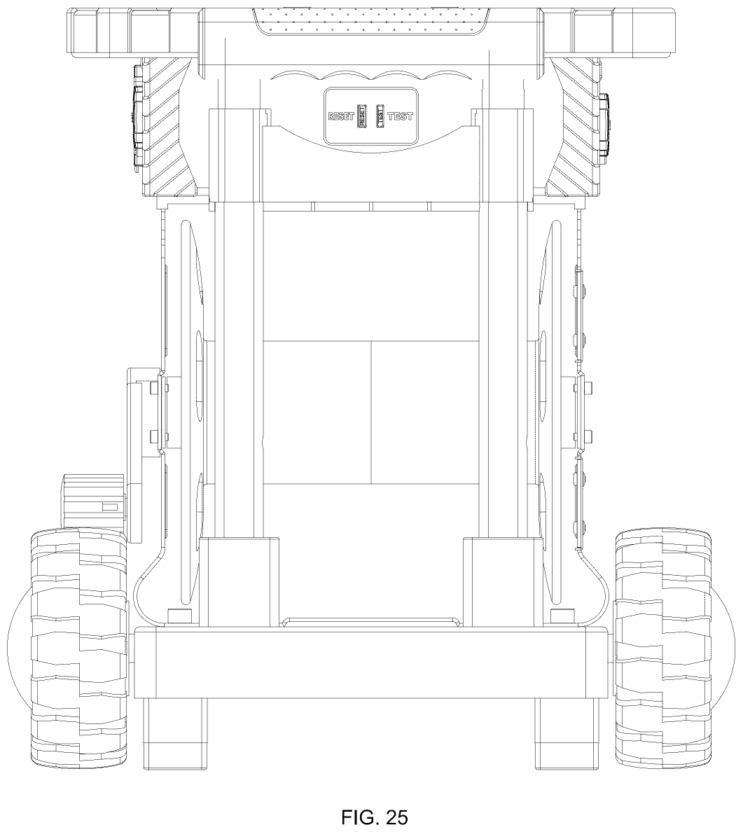

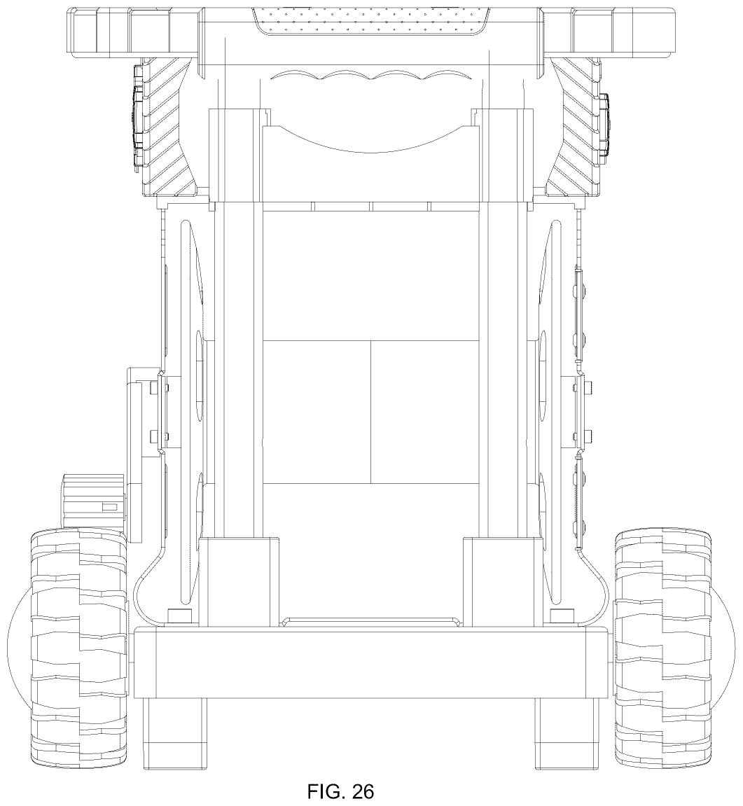

As shown in FIGS. 25 and 26 the box also has an option for a GFCI (220) built into the box, which can protect the power outlets from ground faults. The GFCI is a device that can detect and interrupt the current flow when a ground fault occurs, such as when a person touches a live wire or a device malfunctions. The GFCI is clearly visible and accessible from the a side panel of the box. The GFCI has a test button and a reset button that can be used to check and restore the functionality of the GFCI. The GFCI also has an indicator light that can show the status of the GFCI, such as green for normal, red for fault, or off for no power.

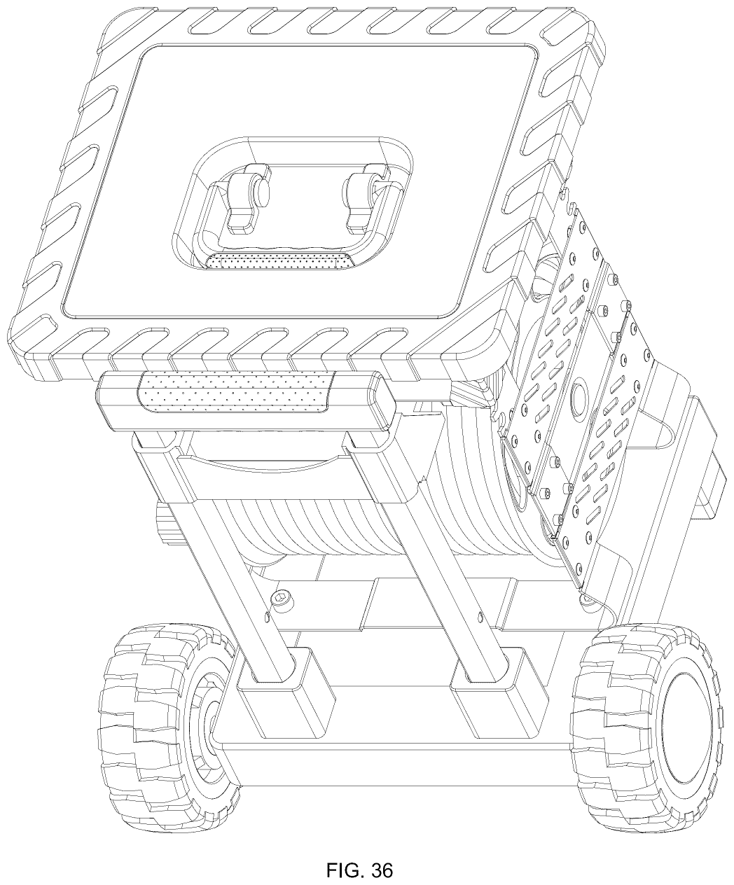

As shown in FIGS. 18, 20, 28, and 36-38, the box also has a cord spindle and a crank (e.g., on a collapsible dolly on which the box is mounted), which can help store and manage a power cord neatly. The cord spindle is a cylindrical device that can wind and unwind the power cord around a midsection of the spindle. The cord spindle is attached to the box by screws or other suitable means. The cord spindle can rotate freely or be locked in a fixed position by a latch or other suitable means. The crank is a lever that can be used to manually rotate the cord spindle and wind or unwind the power cord. The crank is attached to the side of the cord spindle by screws or other suitable means. The crank can be folded or extended by a hinge or other suitable means. The power cord is a standard 15, 20 or 30 A extension cord that can provide the power input to the box. The power cord has a power plug at one end that can be plugged into a power source, such as a standard 15 or 20 amp electrical outlet, or a 15, 20 or 30 amp electrical outlet on a generator/power inverter. The power cord has a power socket (245) at the other end that can be plugged with the power connection on the side of the box. As shown in FIGS. 36-38, an end of the cord may be secured in the catch or notch to protect against the cord unraveling on its own from the spindle. The catch is provided for the power socket on the side of the dolly, which can help secure and manage the power cord more easily and neatly. An end of the cord may be secured in the catch or notch to prevent damage to the cord from unwinding when transporting the unit. The catch is a hook, notch or a clip that can hold the power socket in place. The catch is attached to the side of the dolly by screws or other suitable means. Some embodiments may be tested and certified to electrical & safety codes and requirements, or otherwise follow UL standards, North American codes, safety requirements and regulations.

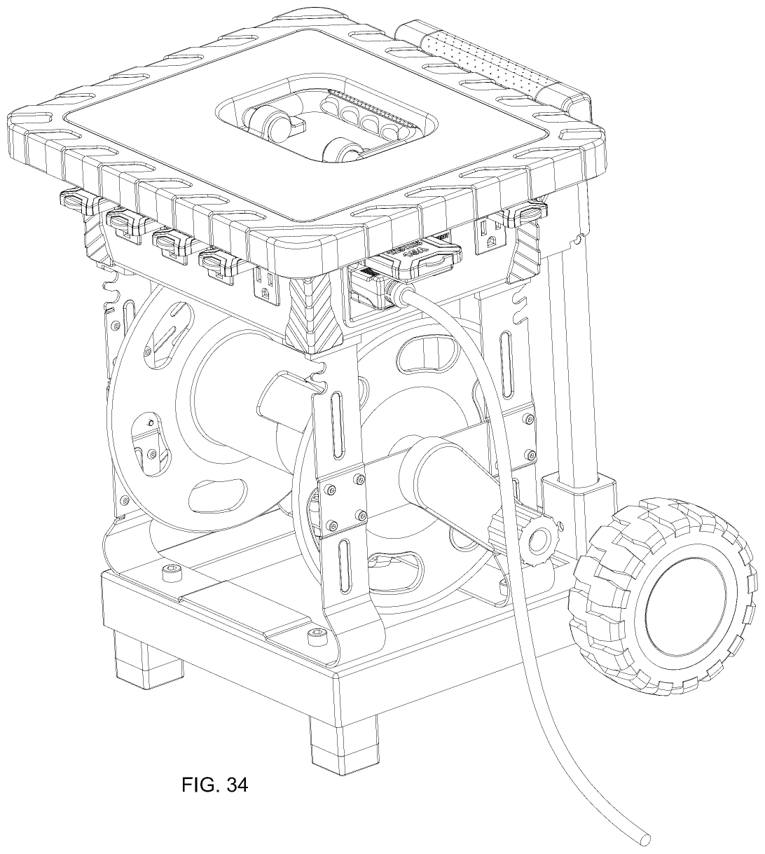

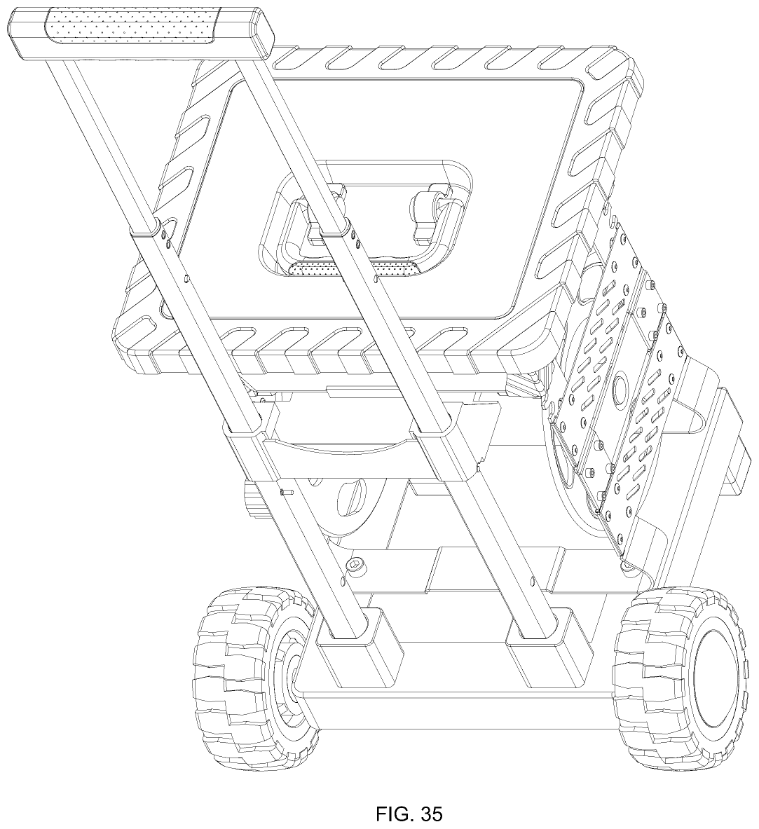

As shown in FIGS. 34-35, the box also has a collapsible dolly (250) with wheels (255) that can move the box easily. The dolly is a device that can support and transport the box on the ground. The dolly comprises a dolly-base and a dolly-handle. The dolly-base is a flat platform that can hold the box and spindle securely via uprights. The dolly-base is attached to the bottom of the box by screws or other suitable means. The dolly-base has wheels that facilitate transporting the box to and around the job site, whereas the other two “legs” on the base have rigid “feet” to ensure that the box remains stationary while in use and in storage. The wheels are attached to the corners of the dolly-base by axles or other suitable means. The wheels are made of a durable material, such as rubber, plastic, or metal. The dolly-handle is a pair of rods that can be used to pull and push the box on the ground. The dolly-handle is attached to the dolly-base. The dolly-handle can be folded or extended by a latch, pin, or other suitable means. The dolly-handle has a grip that can be held by the user comfortably. The grip is made of a soft and ergonomic material, such as rubber, plastic, or foam.

The box provides a simple, compact, and convenient solution for powering multiple devices at remote worksites, without relying on batteries, inverters, or buckets. The box also has a unique and attractive design that distinguishes it from other portable power distribution devices. The box incorporates various features and improvements, such as more power outlets, USB ports, GFCI protection, elevated base, cord spindle, and collapsible dolly, that enhance the usability, durability, mobility, and versatility of the box.

Although the method and apparatus is described above in terms of various exemplary embodiments and implementations, it should be understood that the various features, aspects, and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all the various components of a module, whether control logic or other components, might be combined in a single package or separately maintained and might further be distributed across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A portable power distribution box that is capable powering more than five (5) and at least eight (8) items while complying with UL and OSHA safety regulations where the portable power distribution box includes a foldable handle, two legs, a plurality of power outlets, a power switch, a power connection, at least one USB port, a GFCI, outlet covers, and eaves.

2. A portable power distribution box that is capable powering more than five (5) and at least eight (8) items while complying with UL and OSHA safety regulations where the portable power distribution box includes a foldable handle, a collapsible dolly, a plurality of power outlets, a power switch, a power connection, at least one USB port, a GFCI, outlet covers, eaves, a cord spindle, a crank, and a catch.

3. A portable power distribution system comprising:
a housing with a top, bottom, and four sides;
a foldable handle attached to the top of the housing;
a plurality of power outlets disposed on at least two sides of the housing;
a power switch;
a power connection;
at least one USB port;
a Ground Fault Circuit Interrupter (GFCI);
outlet covers for the power outlets;
eaves extending from the top of the housing over the sides;
a collapsible dolly attached to the bottom of the housing;
a cord spindle attached to the collapsible dolly;
a crank connected to the cord spindle; and
a catch for securing a power cord;
wherein the portable power distribution system is capable of powering at least eight items while complying with UL and OSHA safety regulations.

4. The portable power distribution box of claim 2, wherein the collapsible dolly includes wheels for improved mobility.

5. The portable power distribution box of claim 2, wherein the cord spindle is capable of storing and managing a power cord.

6. The portable power distribution box of claim 2, wherein the crank is used to wind and unwind a power cord on the cord spindle.

7. The portable power distribution box of claim 2, wherein the catch is configured to secure a power socket of an input power line.

8. The portable power distribution box of claim 2, wherein the power connection is compatible with a 110-125 VAC input.

9. The portable power distribution box of claim 2, wherein the power switch includes a built-in resettable circuit breaker for overload protection.

10. The portable power distribution box of claim 2, wherein the plurality of power outlets includes at least eight power outlets.

11. The portable power distribution box of claim 2, wherein the at least one USB port is capable of charging portable electronic devices.

12. The portable power distribution box of claim 2, wherein the GFCI includes test and reset buttons accessible on one of the four sides of the box.

13. The portable power distribution box of claim 2, wherein the outlet covers are configured to protect the power outlets from moisture and dust.

14. The portable power distribution box of claim 2, wherein the eaves provide additional protection to the power outlets, power switch, power connection, and GFCI from moisture and dust.

15. The system of claim 3, wherein the power connection is compatible with NEMA 5-15P, NEMA 5-20P, NEMA L5-20P, or NEMA L14-30P configurations.

16. The system of claim 3, wherein the housing is made of a durable and weather-resistant material.

17. The system of claim 3, wherein the foldable handle can be locked in a folded or an erect position.

18. The system of claim 3, wherein the power outlets are spaced apart to accommodate oversized transformer plugs.

19. The system of claim 3, further comprising a separate resettable circuit breaker for overload protection.

20. The system of claim 3, wherein the collapsible dolly includes a handle that can be extended for moving the power distribution system.
